(19) United States
(12) Patent Application Publication
(10) Pub. No.: US 2022/0108007 A1
(43) Pub. Date: Apr. 7, 2022

(54) Firmware Protection

(71) Applicant: VDOO CONNECTED TRUST LTD., Tel Aviv (IL)

(72) Inventors: Daniel Zatutschne-Marom, Netanya (IL); Omer Schory, Givatayim (IL)

(21) Appl. No.: 17/492,736

(22) Filed: Oct. 4, 2021

Related U.S. Application Data
(60) Provisional application No. 63/086,614, filed on Oct. 2, 2020.

(51) Int. Cl. G06F 21/54; G06F 21/55; G06F 21/57

(52) U.S. Cl. CPC G06F 21/54; G06F 21/577; G06F 21/556; G06F 21/554

(57) ABSTRACT

A method, apparatus and product including: obtaining metadata about a firmware, wherein the metadata comprises one or more constraints on execution of a system call by the firmware; during execution of the firmware, identifying a system call event, wherein the system call event comprises an invocation of the system call; determining that the system call event violates the one or more constraints on the execution of the system call; and in response to said determining that the system call event violates the one or more constraints, performing a responsive action.

### CROSS-REFERENCE TO RELATED APPLICATION

This application claims the benefit of Provisional Patent Application No. 63/086,614, titled “Firmware Protection”, filed Oct. 2, 2020, which is hereby incorporated by reference in its entirety without giving rise to disavowment.

### TECHNICAL FIELD

The present disclosure relates to firmware protection in general, and to methods, systems, and products of protecting firmware devices from memory corruption attacks, in particular.

### BACKGROUND

Embedded systems are proliferating due to the expansion of the Internet Of Things (IoT), such as IoT wearables, drones, smart homes, smart buildings, video surveillance, 3D printers, or the like. While some embedded systems can be relatively simple, such as embedded systems without user interfaces, others are more complex and may offer sophisticated capabilities. Often, embedded systems use operating systems or language platforms tailored to embedded use, particularly where real-time operating environments are served.

### BRIEF SUMMARY

One exemplary embodiment of the disclosed subject matter is a method comprising: obtaining metadata about a firmware, wherein the metadata comprises one or more constraints on execution of a system call by the firmware; during execution of the firmware, identifying a system call event, wherein the system call event comprises an invocation of the system call; determining that the system call event violates the one or more constraints on the execution of the system call; and in response to said determining that the system call event violates the one or more constraints, performing a responsive action.

Optionally, the one or more constraints comprise a constraint over an argument value of an argument of the system call, wherein the constraint over the argument value excludes at least one legal value of the argument.

Optionally, the one or more constraints comprise a constraint on a call chain that invoked the system call, wherein the call chain comprises an ordered sequence of calling functions.

Optionally, the method comprises analyzing a call stack to identify a current sequence of calling functions in the call stack; and determining that the current sequence of calling functions violates the constraint on the call chain.

Optionally, the one or more constraints comprise a temporal constraint on arguments provided with the system call, wherein the temporal constraint is determined based on previous executions of the system call.

Optionally, the one or more constraints comprise a constraint on a calling function that invoked the system call.

Optionally, the constraint on the calling function that invoked the system call is a temporal constraint.

Optionally, the constraint comprises a constraint on a memory location of the calling function that invoked the system call.

Optionally, one or more memory locations are authorized for the being calling functions of the system call, wherein the constraint defines that the memory location of the calling function must belong to the one or more memory locations.

Optionally, the one or more constraints comprise a constraint on a memory location from which the system call is invoked, wherein the constraint on the memory location is a constraint that the memory location is included in a collection of one or more authorized memory locations with respect to the system call.

Optionally, the metadata comprises a collection of one or more memory locations from which the system call can be invoked, wherein the one or more constraints on execution of the system call is based on the collection; wherein said determining that the system call event violates the one or more constraints on the execution of the system call comprises determining that the system call is invoked from a location that is not in the collection.

Optionally, the metadata is determined using static analysis performed without executing the firmware; dynamic analysis performed by executing the firmware prior to the execution of the firmware, and prior to identifying the system call event; symbolic execution performed while tracking symbolic values of the firmware; concolic execution performed while tracking both symbolic and concrete values of the firmware, or the like.

Optionally, the metadata is determined using a dynamic analysis, wherein said dynamic analysis comprises: obtaining a log generated during a training phase of the firmware, wherein during the training phase of the firmware, states and activities of the firmware are continuously polled and recorded in the log, wherein during the training phase the firmware is tested with a plurality of system call events; correlating results of the training phase with states and activities recorded in the log to determine normal and abnormal behavior of the firmware during the plurality of system call events; and based on said correlating, defining the one or more constraints on the execution of the system call.

Optionally, the method comprises mapping, based on said correlating, one or more abnormal behaviors of the firmware with one or more associated attack types utilized for testing the firmware during the training phase; and based on said mapping the one or more abnormal behaviors, determining a risk score of the system call event.

Optionally, the metadata comprises a collection of one or more memory locations of one or more respective calling functions that are configured to call the system call, wherein the one or more constraints on execution of the system call is based on the collection; wherein said determining that the system call event violates the one or more constraints on the execution of the system call comprises determining that the system call is called by a function that is not listed in the collection.

Optionally, the responsive action comprises terminating the system call event; terminating a process executing the system call; reporting the system call event, or the like.

Optionally, the method comprises determining a risk score of the system call event, wherein said performing the responsive action is performed based on the risk score of the system call event being above a threshold.

Optionally, the method comprises identifying the system call event at a kernel mode of an operating system over which the firmware is executed.

Optionally, said identifying the system call event, said determining that the system call event violates the one or more constraints on the execution of the system call, and said performing the responsive action are performed by a runtime agent that is executed on the firmware and which is not part of an operating system over which the firmware is executed.

Optionally, the firmware is executed over an operating system, wherein the system call event complies with constraints of the operating system, and violates the one or more constraints.

Optionally, the firmware is executed over an operating system, wherein the one or more constraints prevent a system call event that is allowed according to the operating system from being executed by the operating system.

Another exemplary embodiment of the disclosed subject matter is a computer program product comprising a non-transitory computer readable storage medium retaining program instructions, which program instructions when read by a processor, cause the processor to: obtain metadata about a firmware, wherein the metadata comprises one or more constraints on execution of a system call by the firmware; during execution of the firmware, identify a system call event, wherein the system call event comprises an invocation of the system call; determine that the system call event violates the one or more constraints on the execution of the system call; and in response to said determining that the system call event violates the one or more constraints, perform a responsive action.

Yet another exemplary embodiment of the disclosed subject matter is an apparatus comprising a processor and coupled memory, the processor being adapted to: obtain metadata about a firmware, wherein the metadata comprises one or more constraints on execution of a system call by the firmware; during execution of the firmware, identify a system call event, wherein the system call event comprises an invocation of the system call; determine that the system call event violates the one or more constraints on the execution of the system call; and in response to said determining that the system call event violates the one or more constraints, perform a responsive action.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 illustrates a flowchart of a method, in accordance with some exemplary embodiments of the disclosed subject matter;

FIG. 2 illustrates a flowchart of a method, in accordance with some exemplary embodiments of the disclosed subject matter;

FIG. 3 illustrates a flowchart of a method, in accordance with some exemplary embodiments of the disclosed subject matter; and

FIG. 4 illustrates a block diagram of an apparatus, in accordance with some exemplary embodiments of the disclosed subject matter.

### DETAILED DESCRIPTION

One technical problem dealt with by the disclosed subject matter is verifying that a firmware, e.g., of an embedded system, provides or performs functions properly without being subject to vulnerabilities, security breaches, or the like. Firmware may be low-level software component which can directly access hardware. In some cases, a firmware could have memory corruption vulnerabilities which may be exploited by a threat actor, such as an attacker or a malicious user, e.g., to perform unauthorized actions within a computer system. In some exemplary embodiments, memory corruption vulnerabilities and attacks that exploit them, e.g., especially in the embedded devices domain, remain one of the major issues in computer security. In some cases, within the embedded systems world, cheaper and more common low-end CPU versions do not contain security features such that the majority of embedded devices are left vulnerable to even simple attacks that have been eradicated in the desktop and server world.

Another technical problem dealt with by the disclosed subject matter is monitoring and identifying exploitations of memory corruption vulnerabilities in a device such as an Internet of Things (IoT) device. As embedded systems are proliferating, the need for protection of such embedded systems is also increasing. In some cases, it may be desired to identify exploitations of vulnerabilities, e.g., automatically, without requiring to manually test or identify vulnerabilities, which may be time consuming task that is difficult, expensive, and requires highly skilled human resources. In some exemplary embodiments, a vulnerability of a firmware may include a weakness of the firmware that may be exploited by a threat actor, such as an attacker or a malicious user, to perform unauthorized actions within a computer system. In some cases, before leaving the factory, firmware-based devices may not be sufficiently protected, thus making them vulnerable to attacks during runtime. In some exemplary embodiments, vulnerabilities of devices may be exploited by hackers and other malicious users to implement memory corruption attack vectors, such as stack overflow attacks. A potential vulnerability may be detected, for example, by a test that can be performed to determine whether the firmware functions properly, whether the firmware may be exploited by the attacker using the potential vulnerability, or the like.

Yet another technical problem dealt with by the disclosed subject matter is to prevent an attacker from exploiting a memory corruption vulnerability during runtime. In some exemplary embodiments, it may be desired to protect the firmware against such exploitations during runtime, to identify attack patterns, or the like. In some exemplary embodiments, it may be desired to protect firmware against memory corruption exploits such as buffer overflows on binary programs that are executed on the firmware device.

Yet another technical problem dealt with by the disclosed subject matter is to mitigate memory corruption attacks that are specifically tailored towards embedded systems, or any other memory corruption attacks. In some exemplary embodiments, embedded systems may not have existing protections such as hardware protections against memory corruption attacks, e.g., code reuse attacks such as return-oriented programming (ROP) attacks and lesser memory corruption such as stack overflow attacks. Exploits such as return oriented programming, a technique used to execute code without injecting binary executable code, are possible even on machines with strict instruction alignment and fixed length instructions. It may be desired to ensure that code is only used for its designed purpose. In some exemplary embodiments, embedded systems may have limited resources, e.g., hardware resources, which may result with a lack in protection mechanisms that may be introduced in other domains, e.g., in the desktop and server world.

In some exemplary embodiments, memory corruption attacks may comprise code injection, code reuse attacks, or the like. In case of code injection, the attacker introduces completely new code into memory and redirects control flow to it. Code reuse attacks on the other hand leverage code already existing in a process, and redirects control flow to selected code chunks. Code reuse attacks can operate at different levels of granularity, either targeting whole library functions (commonly referred to as “return-to-library”) or small code chunks of the program that are stitched together (i.e., “gadgets”). Terms such as hijacking or code hijacking reflect how attacks on code integrity do not have to involve code injection, but rather may take control of code that is already present. In some exemplary embodiments, code reuse attacks circumvent traditional program protection mechanisms by constructing exploits from code already present within a process. For example, a typical data execution prevention cannot defend firmware against this attack because the adversary did not use malicious code but rather combined “good” instructions by changing return addresses.

In some exemplary embodiments, an ROP attack may be a type of code reuse attack, which does not inject malicious code but rather uses instructions that are already present in the system by manipulating return addresses, thereby chaining together arbitrary blocks of code. In some exemplary embodiments, return-oriented programming builds on the borrowed code chunks approach and extends it to provide Turing complete functionality to the attacker, including loops and conditional branches. In some exemplary embodiments, attackers may have one or more resources that may be utilized for implementing ROP attacks, such as an ROP compiler that may be specifically tailored to identify and classify gadgets, or the like. In some exemplary embodiments, an attack has to cause a program's execution flow to deviate from its intended path in order to perform code reuse attacks.

Yet another technical problem dealt with by the disclosed subject matter is to detect and protect the firmware from attacks which may seek to divert or alter the flow of execution of a program. In some cases, an adversary may manipulate the call stack by taking advantage of a bug in the program, such as a buffer overflow (also referred to as “buffer overrun”), to deviate the execution flow. In some exemplary embodiments, in order to utilize return-oriented programming, attacks such as control-data attacks may be implemented to exploit buffer overflows or other vulnerabilities, by overwriting a return address in the stack, a function pointer, or some other piece of control data, and thereby deviating a program's execution flow from its intended path.

In some exemplary embodiments, in order to deviate a program's execution flow from its intended path, an attacker may hijack program control flow, e.g., by exploiting a buffer override vulnerability, a buffer overflow vulnerability, a stack-smashing vulnerability, or the like. In some exemplary embodiments, ROP attacks may be directed to obtaining access to the shellcode by invoking stack overflow and obtaining the control flow this way. The stack may be flooded until a desired memory address is inserted and executed. In some cases, in such vulnerabilities, a function that does not perform properly will accept more input data than it can store properly. In case the data is being written onto the stack, the excess data may overflow the space allocated to the function's variables and overwrite the return address. For example, during a buffer overflow vulnerability, a subroutine return address on a call stack may be replaced by an address of a subroutine that is already present in the process' executable memory, thus ridding the attacker of the need to inject their own code. This address will later be used by the function to redirect control flow back to the caller. In case it has been overwritten, control flow will be diverted to the location specified by the new return address.

In some exemplary embodiments, although the attacker could make the code return to any memory location, the C standard library (“libc”) is the most likely target, as it is almost always linked to the program, and it provides useful calls for an attacker. For example, libc provides the system function which may be used to execute shell commands. In some exemplary embodiments, entire library files or functions may be utilized, or alternatively chunks of library functions (‘gadgets’) may be used to exploit buffer overrun vulnerabilities. As the system files, as well as most libraries and files, are located in libc, attackers may jump or return to libc instead of injecting code, thus performing a return-into-libc attack (also referred to as “return-to-libc”). In some exemplary embodiments, gadgets of the binary are typically chosen so that each gadget ends in a return instruction or equivalent, which, in case the attacker has control of the run-time stack, allows control to flow from one sequence to the next. In some exemplary embodiments, when a call is made to an address, it is pushed to the stack and the stack pointer is moved to point on the address.

In some exemplary embodiments, a call stack (also referred to as an execution stack, program stack, control stack, run-time stack, machine stack, or merely “the stack”) may be configured to keep track of the point to which each active subroutine, e.g., which has been called but is yet to complete execution, should return control when it finishes executing. After completing execution of the active subroutine, a control should be handed back to the point of call. However, control-data attacks may allow the attacker to gain control over the execution stack by overwriting the function return address and replacing it with a pointer to a gadget of the attacker's choice.

For example, a local program that receives a value that is too big for the variable (e.g., as part of a stack overflow attack), causes the value to be overwritten in local stack data, including the saved pointer, and most importantly, the return address. When the local program returns, it pops the return address off the stack and jumps to that address. Thus, the attacker has overwritten the return address with a pointer to the stack buffer value, which now contains attacker-supplied data. This way the attacker may divert the flow of control of the program to other parts of memory and thus breach security.

Yet another technical problem dealt with by the disclosed subject matter may be providing rich and full reports of events and states of the device that are associated with a detected vulnerability, e.g., to further enhance a mitigation effort. For example, providing full reports may enable users to understand the root causes and types of attacks and enhance efforts of preventing future exploitation of memory corruption vulnerabilities. In some exemplary embodiments, it may be desired to identify attacks on a firmware during runtime, for example, automatically. In some cases, it may be desired to evaluate attacks on a firmware correctly based on a risk score, importance, or the like. For example, it may be desired to determine which attacks or vulnerabilities should be ranked low in an important scale.

One technical solution of the disclosed subject matter may be to obtain metadata about a firmware. In some exemplary embodiments, the metadata may indicate one or more constraints on an execution of one or more system calls by the firmware. In some exemplary embodiments, during execution of the firmware, system call events which may invoke respective system calls, may be identified. In some exemplary embodiments, a system call event may be determined to violate or to comply with the one or more constraints on the execution of the system calls. In some exemplary embodiments, in response to determining that a system call event violates the one or more constraints, a responsive action may be performed. In some exemplary embodiments, since code reuse attacks such as ROP attacks start with corrupting the memory, and continue with redirecting the control flow to either plain shellcode or a series of ROP gadgets in the binary, an exploit has to invoke system calls to use functionality beyond pure computation. Accordingly, imposing constraints on executions of system calls by the firmware may tackle the security problem and protect the firmware from ROP attacks and lesser memory corruption attacks.

It is further noted that the phrase ‘system call’, as used herein, may refer to a computer program request for a service from the kernel of the operating system on which the program is executed. Additionally, or alternatively, the phrase ‘system call’ may refer to general system Application Programming Interface (API) calls with no context switching between a user mode and a kernel mode, such as in the case of some Real-Time Operating Systems (RTOS). In some exemplary embodiments, a system call may cause an invocation of a function, such as a particular library, an operating system API call, or the like.

In some exemplary embodiments, one or more constraints on the execution of a system call may comprise a constraint on a calling function (or subroutine) that invoked the system call. For example, based on the metadata, certain functions may be allowed to call a certain system call, while others may not. In some cases, a constraint on a calling function that invokes a system call may comprise a temporal constraint on a behavior of the calling function, e.g., which may be determined based on historic behavior of the calling function.

In some exemplary embodiments, one or more constraints on the execution of a system call may comprise a constraint on a call chain, e.g., an ordered sequence of calling functions that invoked the system call. For example, based on the metadata, certain ordered or non-ordered sequences of calling functions may be allowed to invoke a certain system call, while others may not. In some exemplary embodiments, the sequence of calling functions may comprise active subroutines that may be identified in the call stack.

In some exemplary embodiments, one or more constraints on the execution of a system call may comprise a constraint on a memory location of a system call, of a calling function that invoked the system call, or the like. For example, the metadata may provide a mapping of memory locations to corresponding system calls, calling functions, or the like, and only system calls that are invoked from a memory location indicated by the metadata may be performed.

In some exemplary embodiments, a constraint on the execution of a system call may comprises one or more allowed argument values for the system call, one or more allowed argument values for calling functions that can invoke the system call, a mapping of allowed register values with one or more calling functions, an allowed context of the system call, a combination thereof, or the like. In some exemplary embodiments, when a function is initially called, the first thing it typically does is to save the contents of the hardware registers. The register contents at function call time represent the state of the calling function, and this state must be restored when the called function returns.

In some exemplary embodiments, temporal constraints may be determined based on one or more previous executions of a calling function, a system call, a sequence of calling functions, or the like. In some cases, certain sequences of system call arguments, certain calling function arguments, or the like, may be allowed, while others may not be allowed. For example, a temporal constraint may include a constraint on arguments provided with the system call.

In some exemplary embodiments, in case a constraint on the execution of a system call is violated by a system call event that invokes the system call, a responsive action such as terminating the system call event, terminating the system call, terminating the system, terminating the process that is executing the system call, reporting the system call event, or the like, may be performed.

In some exemplary embodiments, a risk score of a system call event may be determined, e.g., based on an identified attack that is associated with the system call event, based on an identified invoker of the system call event, based on a type of attack, or the like. In some exemplary embodiments, a responsive action may be determined, selected, or the like, based on a risk score of the system call event. For example, a responsive action may be performed when a risk score of the system call event is above a defined threshold.

In some exemplary embodiments, the metadata may comprise a list or collection of one or more memory locations which may store system calls, calling functions from which a system call may be invoked, a mapping between them, or the like. In some exemplary embodiments, the metadata may comprise a list (also referred to as ‘collection’) of one or more calling functions in which the system call can be invoked. In some exemplary embodiments, the metadata may indicate whether an order of active subroutines in the call stack is allowed or not. In some exemplary embodiments, the metadata may list one or more allowed call chains, or ordered sequences of the one or more calling functions, which may include an order of subroutines that are allowed to invoke the system call. In some exemplary embodiments, the metadata may comprise one or more forbidden orders of sequences of the one or more calling functions. For example, the metadata may indicate that functions A, B, and C are allowed to invoke a system call in the orders A, AB, BC, and are definitely not allowed to invoke the system call in the order CA, while a function D is never allowed to invoke the system call. In some exemplary embodiments, the metadata may comprise a list of temporal behaviors of a calling function, a system call, or the like.

In some exemplary embodiments, the list may be determined using static analysis of the firmware which may be performed without executing the firmware, dynamic analysis which may be performed by executing the firmware prior to the runtime of the firmware, e.g., during a testing phase, a training phase, or the like. In some exemplary embodiments, the list may be determined prior to the execution of the firmware, e.g., based on a static analysis thereof.

In some exemplary embodiments, based on the list, the constraints on execution of the system calls may be determined. In some exemplary embodiments, a system call event may be determined to violate one or more constraints on the execution of the system call in case the system call is invoked from a location that is not in the list, in case the system call is determined to be invoked from a calling function that is not in the list, or the like. In some exemplary embodiments, a system call event may be determined to violate the one or more constraints on the execution of a system call by analyzing a call stack to identify a call chain thereof, e.g., an ordered sequence of calling functions in the call stack. In some exemplary embodiments, the call chain that caused the system call event may be obtained and analyzed, e.g., to determine whether it is listed in the list, in the collection, or the like.

In some exemplary embodiments, the metadata about the firmware may be obtained by performing a dynamic analysis. In some exemplary embodiments, the dynamic analysis may comprise obtaining a log generated during a testing phase of the firmware, also referred to as a training phase, which may include states and activities of the firmware that were continuously polled and recorded in the log during the testing phase of the firmware. In some exemplary embodiments, during the testing phase, the firmware may be tested with a plurality of system call events, which may represent normal inputs, abnormal inputs, attacks, or the like. In some exemplary embodiments, results of the testing phase may be correlated with states and activities recorded in the log, e.g., to determine normal and abnormal behavior of the firmware during the system call events. In some exemplary embodiments, the one or more constraints on the execution of the system call may be defined based on the determined correlation. In some exemplary embodiments, based on the determined correlation, one or more abnormal behaviors of the firmware may be mapped with one or more associated attack types which may be utilized for testing the firmware during the testing phase. In some exemplary embodiments, a risk score of a system call event may be determined based on the mapping of the behavior of the firmware during the system call event with associated attack types.

In some exemplary embodiments, the metadata about the firmware may be obtained by performing a static analysis. In some exemplary embodiments, the metadata about the firmware may be obtained by analyzing a binary of the firmware, e.g., prior to executing the firmware. In some exemplary embodiments, based on analyzing the binary, first memory locations may be mapped to respective system calls in the firmware which may be stored at the first memory locations. In some exemplary embodiments, based on analyzing the binary, one or more calling functions via which the system call is invocable may be identified in the firmware. In some exemplary embodiments, based on analyzing the binary, one or more second memory locations may be mapped to the one or more calling functions via which the system call is invokable, which may be stored at the one or more second memory locations, respectively. In some exemplary embodiments, based on analyzing the binary, one or more allowed or forbidden sequences, including at least a portion of the one or more calling functions, may be identified.

In some exemplary embodiments, the metadata about the firmware may be obtained using symbolic execution, concolic execution, or the like. In some exemplary embodiments, symbolic execution and/or concolic execution may be used to identify memory locations from which system calls can be executed, allowed call chains, allowed calling functions, or the like. In some exemplary embodiments, symbolic execution may simulate execution of the firmware while tracking symbolic values for inputs. Constraints over the symbolic values may be determined and tracked, such as based on conditional branching instructions whose conditions' evaluations depend on the symbolic values. In some exemplary embodiments, the symbolic execution may be performed using an interpreter that assumes symbolic values for inputs, and expresses possible outcomes of each conditional branch in terms of those symbols. In some exemplary embodiments, the interpreter may determine possible inputs that trigger each branch, thereby obtaining all mathematically possible values for the program's constraints. In some exemplary embodiments, concolic execution may combine symbolic execution while tracking, for each branch, a concrete state, which may be utilized to improve identification of reachable conditions, without evaluating conditions over the symbolic values.

In some exemplary embodiments, based on the constraints, system call events may be classified as allowed or not allowed, e.g., at a kernel mode of an operating system of the firmware. In some exemplary embodiments, a wrapper may be created around a system function of the firmware's kernel, so that every system call, e.g., invoked at a user mode of the operating system by a user, may go through the wrapper. In some exemplary embodiments, the classification of the system call event may be determined at a runtime agent which may be deployed within the wrapper. Additionally or alternatively, some operating systems, such as RTOS, may not distinguish between kernel mode and user mode. In some exemplary embodiments, operating systems may provide an operating system API that can be utilized to identify the system call event. For example, using an operating system API, the agent may register to receive notifications when certain system calls are invoked.

In some exemplary embodiments, constraints indicating whether a system call event is allowed or not may be provided to the runtime agent, e.g., to enable the runtime agent to protect the firmware from memory corruption attacks. In some exemplary embodiments, a report of system call events that violate the constraints may be generated, e.g., by the runtime agent, to include attributes of the system call event that were not allowed.

One technical effect of the disclosed subject matter is that during execution of a firmware, e.g., together with a configured runtime component, the firmware may not be susceptible to memory corruption vulnerabilities. In some exemplary embodiments, the disclosed subject matter may enable real time detection and prevention of memory corruption attacks

Another technical effect of the disclosed subject matter is to enforce strong restrictions on how system calls can be invoked, e.g., to guarantee that only system calls that are actually used by a program can be invoked by a corresponding process. These features provide a practical, efficient and effective defense to mitigate exploitation of memory corruption attacks on embedded systems, and vastly limit the options for successful code injection attacks and code reuse attacks.

Yet another technical effect of the disclosed subject matter may be providing a runtime agent which may block, report, or the like, any system call event occurring during runtime that violates the constraints. In some exemplary embodiments, the runtime agent may protect the firmware from attacks.

Yet another technical effect of utilizing the disclosed subject matter is to detect new vulnerabilities during runtime. In some exemplary embodiments, the runtime agent may identify any abnormal or undefined system call event in the device. Such detections may be utilized to determine new vulnerabilities of the firmware that were not detected during the testing phase, but were exploited during the system call event, and to reduce exploitation of unknown vulnerabilities.

Yet another technical effect of utilizing the disclosed subject matter is to enhance the report of memory corruption attacks to clients and make it more particular and efficient. In some cases, upon identifying an abnormal event, a report including recorded attributes of events, as well as testing results associated with the abnormal event, may be provided. This may save time and improve resource utilization of a computerized framework.

Yet another technical effect of utilizing the disclosed subject matter is to effectively mitigate code injection and reuse exploits, e.g., by utilizing the constraints. This effectively defends against code injection and reuse attacks, while incurring a low performance overhead and, therefore, representing a practical, generic defense for embedded systems. The solution ensures that it only causes overhead whenever a system call is actually invoked, making it applicable to existing device and software configurations.

The disclosed subject matter may provide for one or more technical improvements over any pre-existing technique and any technique that has previously become routine or conventional in the art. Additional technical problem, solution and effects may be apparent to a person of ordinary skill in the art in view of the present disclosure.

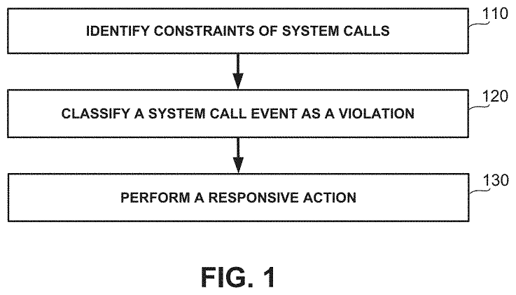

Referring now to FIG. 1 showing a flowchart diagram illustrating a method in accordance with some exemplary embodiments of the disclosed subject matter.

On Step 110, one or more constraints of one or more respective system calls of the firmware may be identified. In order to ensure that system calls are only invoked in a legitimate way, only system calls that comply with the one or more constraints may be allowed to proceed to execution.

In some exemplary embodiments, the one or more constraints may comprise a mapping of one or more memory locations to one or more respective system calls of the firmware. In some exemplary embodiments, system calls may only be allowed to originate from corresponding mapped addresses. In some exemplary embodiments, the one or more memory locations may comprise memory addresses where the one or more system calls are stored. For example, a “write” system call may be invoked from memory 253, and a “read” system call may be invoked from memory 987. According to this example, receiving a write system call from a different location, e.g., from memory 987, may violate the constraint on the memory location of the write system call.

In some exemplary embodiments, the one or more constraints may comprise a mapping of one or more memory locations to one or more respective calling functions that include the invocation of the one or more system calls of the firmware. In some exemplary embodiments, calling functions may only be allowed to originate from corresponding mapped addresses. In some exemplary embodiments, the one or more memory locations may comprise memory addresses where the one or more calling functions are stored. For example, a foo( ) calling function may be located in memory 123 and invoke a “write” system call, while a boo( ) calling function may be located in memory 321 and a “read” system call. According to this example, receiving a write system call from the boo( ) function, e.g., from memory 321, may violate the constraint on a mapping between system calls and the boo( ) function. Additionally, according to this example, receiving a write system call from the foo( ) function from memory 797, may violate the constraint on the memory location of the foo( ) function.

In some exemplary embodiments, the one or more constraints may comprise ordered sequences of one or more calling functions of the firmware. In some exemplary embodiments, system calls may only be allowed to originate from a corresponding sequence of calling functions. For example, an allowed sequence may include foo( ) and then an odd number of function boo( ) and then function goo( ) at least twice. According to this example, receiving an invocation of a system call from a goo( ) function that follows two boo( ) functions may violate the constraint on the allowed sequence.

In some exemplary embodiments, the one or more constraints may comprise temporal behaviors of a calling function, a system call, or the like. In some exemplary embodiments, the temporal behaviors may relate to a content of registers provided as arguments, on a number of arguments provided, or the like. For example, a temporal constraint may define that a system call may only accept arguments when the second argument has a value of 3 or 4. According to this example, receiving an invocation of the system call with the second argument having a value of 5 or 6 may violate the temporal constraint. In another example, a temporal constraint may define that a system call may only accept positive arguments. According to this example, receiving an invocation of the system call that passes arguments with a negative value or a zero value may violate the temporal constraint.

In some exemplary embodiments, constraints may be identified and defined, e.g., to provide a rule-based description and definition of the firmware's expected behavior. In some exemplary embodiments, the constraints may define under which conditions system call events are legal, and under which circumstances they are problematic. In some cases, the constraints may be defined based on static analysis, dynamic analysis, heuristics, manually provided rules, or the like. In some cases, heuristics may be used as a baseline for static analysis. In some cases, the constraints may be utilized during run-time to evaluate whether or not the code is behaving as intended. In some exemplary embodiments, the constraints may impose a restriction on the way that the program is allowed to execute. In some exemplary embodiments, generated constraints may express the manner in which the program is to operate, for example a series of expected function calls, an order thereof, or the like.

In some exemplary embodiments, the one or more constraints may comprise an allowed argument value for the one or more system calls, a mapping of allowed register values with sequences of one or more calling functions that can invoke the one or more system calls, an allowed context of each of the one or more system calls, or the like. In some exemplary embodiments, a context of a system call may comprise a temporal context that is determined as allowed or not allowed based on previous executions of the system call, based on heuristics, or the like. In some cases, the one or more constraints may include temporal constraints which may define whether or not a system call is legal based on an historical context. For example, temporal constraints may include a certain sequence of actions that enable or disable to accept a certain system call event.

In some exemplary embodiments, dynamic analysis may be implemented by a kernel-based testing agent that may be deployed during a testing phase. In some exemplary embodiments, the testing agent may be configured to check system call properties against runtime behavior. In some exemplary embodiments, constraints may be determined during dynamic analysis by executing the firmware under normal operating conditions to determine a set of legitimate paths that may be taken by the firmware, a set of legitimate register contents, a set of legitimate memory locations, or the like. In some exemplary embodiments, constraints may be generated during dynamic analysis by executing the firmware under abnormal operating conditions, e.g., different types of attacks, to determine a set of illegitimate paths that may not be taken by the firmware, a set of illegitimate register contents, a set of illegitimate memory location, or the like.

In some exemplary embodiments, the testing agent may be configured to identify normal and abnormal behaviors of the firmware during a system call, e.g., as part of the dynamic analysis. In some exemplary embodiments, during a testing phase of the firmware which may be configured to test the firmware with a plurality of system call events, the testing agent may continuously poll states and activities of the firmware such as states of firmware registers. In some exemplary embodiments, the testing agent may record in a log the states and activities of the device during the plurality of system call events. In some exemplary embodiments, the testing agent may correlate results of the testing phase with the states and activities recorded in the log to determine normal and abnormal behavior of the firmware during the plurality of system call events. In some exemplary embodiments, upon identifying that a system call event was not present during the testing phase, the system call event may be blocked, terminated, attributes thereof may be reported, or the like.

In some exemplary embodiments, based on a correlation of the results, the testing agent may map one or more abnormal behaviors of the firmware with one or more associated attack types utilized during the testing phase. In some exemplary embodiments, identifying the specific attack type may be useful for reporting the event, for determining a responsive action, or the like. For example, a first type of attack may cause the responsive action to terminate the system, while a second type of attack may cause the responsive action to disable the system call.

In some exemplary embodiments, based on a correlation of the results, the testing agent may define the one or more constraints of the system calls. In some exemplary embodiments, the testing agent may identify, during normal operation of the firmware, what system calls are invoked, by who and how, and what system calls are invoked, by who and how, during abnormal operation of the firmware. In some exemplary embodiments, events in which system calls are invoked during abnormal operation of the firmware may be identified as violation events, and may be added to a list of constraints that each system call event is to comply with. In some exemplary embodiments, a system call event may include a type of call, a location from which the call is made, parameters of the call such as a content of registers, contents of the program counter (PC), an instruction opcode, a flag, or other properties associated with the process or call.

In some exemplary embodiments, a risk score of a system call event may be determined based on an associated attack type. In some exemplary embodiments, types of attacks performed during the testing phase may be correlated with recorded events during the attacks, and their risk may be classified according to a type of the attack. For example, a certain testing may include performing a certain type of a memory corruption attack, and result with abnormal behaviors of the firmware that are scored according to the severity of the memory corruption attack type. In some exemplary embodiments, based on a correlation of the results, the testing agent may classify one or more temporal contexts of system calls as allowed or not allowed.

In some exemplary embodiments, additionally or alternatively to the dynamic analysis, system call events may be classified based on constraints identified with a static analysis. In some cases, the static analysis may be applied on the firmware's binary without executing the firmware, e.g., to identify memory locations of system calls, memory locations of calling functions, arguments that may be passed for system calls, arguments that may be passed for calling functions, allowed sequences of calling functions, and any other constraints that may be associated with each system call. The constraints on the system calls may be extracted from the binary executable.

In some exemplary embodiments, the static analysis may comprise analyzing a binary of the firmware to map the one or more system calls to one or more first memory addresses, where the system calls may be stored. In some exemplary embodiments, the static analysis may comprise analyzing the binary of the firmware to map one or more second memory addresses to one or more calling functions via which the one or more system calls may be invoked. In some exemplary embodiments, the one or more calling functions may be stored at the one or more second memory addresses, respectively. In some exemplary embodiments, the static analysis may comprise analyzing the binary of the firmware to identify one or more allowed sequences of the one or more calling functions. In some exemplary embodiments, based on the static analysis, the one or more first and second memory addresses may be mapped with corresponding system calls or functions. In some exemplary embodiments, a system call invoked by a system call event may be inspected to identify whether a function that invoked the system call is of the one or more calling functions, whether a memory address of the system call is the corresponding first memory address, whether a memory address of the function is of the one or more second memory addresses, and whether a sequence or call functions up to the function is of the one or more allowed sequences. In some exemplary embodiments, the static analysis may comprise analyzing the binary of the firmware to identify a mapping of allowed register values with at least one associated sequence of one or more calling functions that can invoke the one or more system calls. In some exemplary embodiments, the static analysis may comprise analyzing the binary of the firmware to identify at least one allowed context of the one or more system calls.

In some exemplary embodiments, system call events may be classified based on constraints identified with the static analysis. In some exemplary embodiments, the static analysis may identify constraints based on heuristics or on historic performance information associated with the one or more system calls.

In some exemplary embodiments, manual rules or heuristics may be provided, directly or indirectly, by a user such as a domain expert, a developer, or the like, to define the constraints. In some exemplary embodiments, the manual rules may identify names of files that are not allowed to invoke system calls, stages in which system calls are not allowed, events in where certain system calls are not allowed to be invoked, parameters of system calls that are not allowed for a type of system calls, or the like.

On Step 120, system call events may be classified as allowed or not allowed based on the identified constraints, e.g., which may be obtained by a dynamic analysis, a static analysis, a combination thereof, or the like. In some exemplary embodiments, a classification of system call events may be determined, e.g., based on identifying whether or not they comply with the one or more constraints, violate the one or more constraints, or the like. In some exemplary embodiments, upon identifying system calls originating from mapped addresses, a sequence of events that caused the system calls may be identified and analyzed to determine whether the system calls are allowed. In some exemplary embodiments, the invoker of the system calls may be required to comply with the constraints. In some cases, the registers provided as arguments may be required to have a specific content when system calls are performed at calling functions, which may be determined based on dynamic or static analysis. In some cases, other constraints, e.g., which are not put on registers, may be set as well.

In some exemplary embodiments, during runtime, the runtime agent may identify any system call event, and monitor associated contents of registers, sequences of system calls in the call stack, memory locations of the invokers, memory locations of the system calls, or the like, e.g., to identify whether the system call event violates the constraints.

In some exemplary embodiments, the classification of the system call event may be determined while the operating system is at a kernel mode. In some exemplary embodiments, a wrapper may be formed around the kernel, around the system function, or the like, and a runtime agent may be deployed to operate within the wrapper. In some exemplary embodiments, the classification of the system call event may be determined at the runtime agent, e.g., based on the constraints. In some exemplary embodiments, one or more indications of the one the one or more constraints may be provided to the runtime agent, e.g., from the dynamic analysis, the static analysis, a combination thereof, or the like. In some exemplary embodiments, providing the one or more indications may enable the runtime agent to protect the firmware from memory corruption vulnerabilities.

In some exemplary embodiments, a wrapping in the binary may be created, a kernel mode may be activated, or the like, e.g., to avoid manipulations and exploitations at a user memory mode, or at any other mode. In some exemplary embodiments, in order to have an effect on the system, an attacker has to request operating system services at some point, i.e., by performing a system call. Without being able to perform a system call, the attacker possibilities are limited to pure computational tasks while operations like file or network I/O as well as process control are impossible.

In some exemplary embodiments, wrapping the kernel or system function thereof may ensure that every system call passes through the wrapper. This means that whenever a system call is made, the wrapper will be called first, which may enable a runtime agent in the wrapper to identify and classify the call. In some exemplary embodiments, a kernel mode may be utilized, e.g., without wrappers. For example, an operating system itself may be configured to classify each system call and block system call events that are not allowed, e.g., without using wrappers. In some exemplary embodiments, when an attempt to invoke a system call is made, before executing or performing the requested call, the runtime agent in the wrapper may ensure that the system call is legitimate according to the constraints, e.g., whether the call system complies with the constraints, is invoked by an authorized location, or the like, and takes a responsive action in case the call is identified as unauthorized.

On Step 130, based on the classification of the system call event, the system call event may be determining to be allowed or not allowed to be performed, e.g., at the runtime agent. In some cases, based on the classification indicating that the system call event is not allowed, a responsive action may be taken such as preventing the system call, terminating the event, warning the user, generating a report about the unauthorized system call, or the like.

In some exemplary embodiments, based on parameters of the system call event, e.g., constraints that were violated, a risk score may be assigned to the system call event or to a sequence of one or more system calls events. In some exemplary embodiments, the risk score may be determined based on an identified type of attack, or regardless of identified attacks. In some exemplary embodiments, the risk score of the system call event may be generated to include a value, e.g., a normalized numeral value, based on heuristics, on a type of system call, on parameters of the system call event, or the like. In some exemplary embodiments, different types of calls may be associated with different risk factors. In some exemplary embodiments, upon identifying that a system call violates one or more constraints, the call may be inspected to determine a name or type of an associated attack. For example, in case dynamic analysis was utilized, an associated attack may be identified based on results of testing the attack during the testing phase.

In some exemplary embodiments, based on a risk score of the system call or of the sequence of one or more system calls, mitigation actions may be determined and applied. In some exemplary embodiments, in case that a risk score of the system call event is above a threshold, the system call event may be terminated, blocked, reported, or the like. In some exemplary embodiments, in case that the system call event complies with the constraints, that the risk score of the system call event is below the threshold, or the like, the system call event may proceed with execution.

In some exemplary embodiments, the runtime agent may generate a report, e.g., based on an identification of a system call event in the firmware that violates one or more constraints. In some exemplary embodiments, the report may comprise attributes of the system call event that are not allowed, the constraints that were violated by the system call event, a suspected type of attack that is implemented in the system call event, a risk score of the system call event, or the like.

In some exemplary embodiments, in case the system call event represents a ROP attack, the risk score may be determined to be associated with the corresponding ROP attack. In some exemplary embodiments, constraints not being met may be associated with a risk level, e.g., according to a specific ROP attack associated with the constraints. For example, an ROP attack may be characterized with certain constraints not being met, e.g., registers having a higher value than required. According to this example, upon identifying that registers have a higher value than allowed, a level of risk associated with the system call event may be determined to be associated with an ROP attack, and may be reported accordingly.

In some exemplary embodiments, this technique enables extending the standard OS's permissions regarding the system calls to allow selective prevention of system calls based on the type of the process attempting to perform the system call, based on a location in the memory of the process attempting to perform the system call, based on temporal rules, or the like, without necessarily requiring the cooperation of the OS.

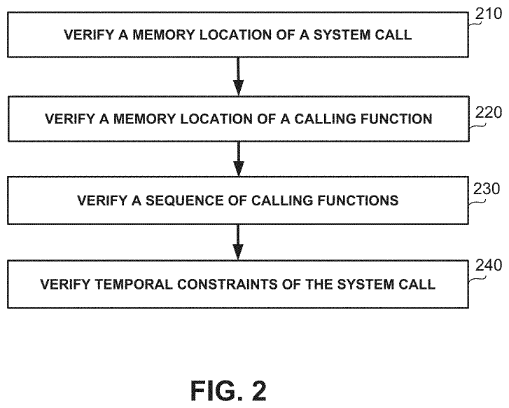

Referring now to FIG. 2 showing a flowchart diagram illustrating a method in accordance with some exemplary embodiments of the disclosed subject matter.

In some exemplary embodiments, it is assumed that the operating system kernel and the underlying hardware, the application binary on disk, and the shared libraries used by the application, are trusted and have not been compromised by the attacker. However, the process memory may not be trusted, e.g., since the attacks that are to be mitigated are based on memory corruption.

On Step 210, upon identifying an invoked system call, a memory location from which the system call was invoked may be extracted and verified. In some exemplary embodiments, a list of permissible memory locations of respective system calls may be retained, including one or more memory locations from which system calls may be invoked. In some exemplary embodiments, a constraint may define a memory location from which the system call may be invoked. In some exemplary embodiments, when a call is made, e.g., a system call or any other type of call, predetermined constraints associated with the call type may be retained and parameters of the call may be examined to determine compliance to the constraints. In some exemplary embodiments, a constraint may define that memory locations that invoke system calls must belong to the listed memory locations. In some exemplary embodiments, the runtime agent may compare listed memory locations to an extracted location of a system call, to determine whether or not the system call is authorized to be invoked from the extracted location, thereby preventing exploitations. For example, in case an attacker overrides a memory address with a system call invocation, the memory address may violate the constraint as it may not be listed as a permissible location for invoking the system call. In some exemplary embodiments, the constraints, such as the list of permissible memory locations, may be generated based on static analysis, dynamic analysis, a combination thereof, or the like, e.g., as identified at Step 110 (FIG. 1).

For example, a system call of a certain type, e.g., type 47, may be identified as being invoked from a certain memory location, e.g., location 1974, with certain parameters, e.g., registers R1, R2, and R3. In some exemplary embodiments, memory location 1974 may be listed as an authorized location from which system calls of type 47 may be invoked. In case a system call of type 47 is invoked from a different location, an unauthorized location, or the like, such as location 7384, an attack may be identified, and mitigation responsive actions may be performed.

On Step 220, a calling function that invoked the system call may be identified, and a memory location of the calling function may be extracted and examined to determine whether the calling function is one of a set of specific calling functions that can initiate the call. In some exemplary embodiments, a list of one or more permissible memory locations of calling functions, that are authorized for the being calling functions of one or more types of system calls, may be retained. In some exemplary embodiments, a constraint on calling functions may define that a memory location of a calling function that calls or invoked a system call of a certain type, must belong to the one or more memory locations of the list. In some exemplary embodiments, the list may be compared, by the runtime agent, to memory locations of calling functions, to active calling functions in the call stack, or the like, to determine whether or not a calling function is authorized for invoking the system call, thereby identifying exploitations. In some cases, an attacker may activate an authorized system call, such as a system call from a memory location that is authorized by Step 210, externally to the permissible calling functions. For example, an attacker may utilize a “goto” or “jump” instruction to activate a legitimate memory address that invokes a system call, without invoking the function call itself. In such cases, the agent may identify the attack by determining that the call stack does not include the call function as an active function.

For example, the set of specific calling functions may include a first function A located at a specific location such as 2014, a second function B located at a specific location such as 1950, and a third function C located at a specific location such as 6157. These functions alone may be authorized to initiate the system call, and only from their matching locations. According to this example, function calls in the call stack may be examined to ensure they only include functions A, B, or C, and that each function is located in the correct memory location. For example, in case a function that is identified in the call stack is associated with a memory location 1342, which does not correspond to a legitimate call function, an attack may be identified.

On Step 230, a current call chain, such as a sequence of calling functions that invoked a current subroutine and is located in the call stack, may be analyzed to determine whether the sequence is allowed, legitimate, complies with a call chain constraint, or the like. In some exemplary embodiments, a constraint such as a call chain constraint may define an ordered sequence of specific calling functions that are allowed to initiate the system call. In some exemplary embodiments, the current sequence of calling functions may be compared to one or more allowed sequences, to one or more forbidden sequences, or the like, to determine whether or not the constraint is complied with. In some exemplary embodiments, mitigation actions may be applied upon determining that the current sequence of calling functions violates a constraint on the ordered sequence of calling functions. In some exemplary embodiments, the runtime agent may be configured to ensure that the function calls in the call stack are from the predetermined set of specific calling functions that are authorized to initiate the call.

In some exemplary embodiments, the constraints may define a content of registers matching each function call, an order thereof, or the like. For example, in case function A is located at memory address 2014 is identified in the call stack as a previous function, a content of a register, e.g., register R1, may be required to be equal to a certain value, e.g., 7, and a content of a second register, e.g., R2, may be required to be greater that a certain value, e.g., a value of a third register R3.

On Step 240, a history of previous system calls executed or attempted to be executed the firmware may be analyzed, e.g., to identify one or more temporal constraints associated with behavioral patterns of the firmware including the system calls, the calling functions invoking the system calls, or the like. In some exemplary embodiments, the behavioral patterns may include temporal constrains on arguments, e.g., in registers, provided with the system call, on register contents at the time of the call, or the like. For example, a temporal constraint may define that in case a call of type 3 is initiated from location 3333, only arguments with values 1, 2, and 4 are permissible, or only a certain pattern of arguments is allowed, e.g., 121212, where each subsequence number is different than the previous number and they only include the values 1 and 2.

In some exemplary embodiments, the temporal constraints may comprise a constraint over an argument value of an argument of the system call. In some exemplary embodiments, the constraint may exclude at least one legal value of the argument, that is theoretically or technically allowed. For example, a function foo(int x) may invoke a system call with the input x, which theoretically can be any number. However, a constraint on the input x may reduce the allowed inputs of foo( ) to only include the values 1 and 2.

In some exemplary embodiments, in response to identifying a violation of constraints or memory source requirements, mitigation actions may be performed in response to any of Steps 210-240. In some exemplary embodiments, mitigation actions may include reporting the occurrence of abnormal behavior, terminating the system call event, terminating the system, terminating the execution of the firmware, deploying a mask over inputs, preventing a scenario from occurring, terminating system calls, or the like.

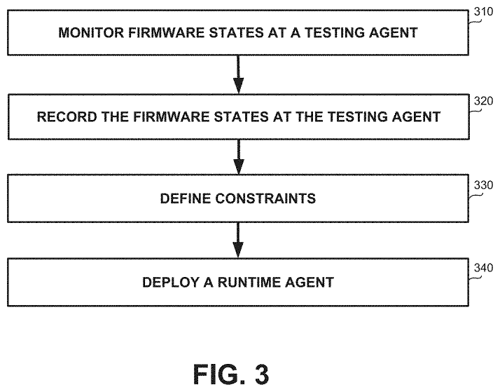

Referring now to FIG. 3 showing a flowchart diagram illustrating a dynamic analysis method in accordance with some exemplary embodiments of the disclosed subject matter.

On step 310, a testing agent may be utilized to monitor, poll, collect, or the like, states and activities of a firmware-based device during a testing phase of the firmware. In some exemplary embodiments, the testing agent may comprise a software agent, a software program, or any agent that is functionally separate from the device's firmware and is deployed during a testing phase that tests the device's firmware. The testing agent may be a general-purpose software component that is used for testing various different firmware. In some cases, the firmware may be integrated with a device such as an IoT device, an embedded device, a computing device, or the like. In other cases, the firmware may be independent of the device.

In some exemplary embodiments, the testing phase of the firmware may comprise exposing the firmware to inputs such as sensor-based inputs, e.g., using fuzz testing, black box testing, or the like, and examining the output. In some exemplary embodiments, fuzz testing may be employed to test the device, e.g., from a remote location. In some exemplary embodiments, fuzzing may be performed to provide variations of potential inputs to the IoT device. In some exemplary embodiments, the IoT device may react to the input received from the web server and perform intended or unintended actions, events, functionality, or the like. In other cases, any other party such as a server, a manual tester, or the like, may run the tests.

In some exemplary embodiments, the testing phase may be configured to implement a testing policy including the one or more tests. In some exemplary embodiments, tests may be executed according to the testing policy. In some exemplary embodiments, the tests may include a plurality of memory corruption attacks on the firmware such as code reuse attacks, code injection attacks, or any other attack or test. In some exemplary embodiments, in addition to attacks, the tests may include a plurality of legitimate allowed input, e.g., configured to identify a correct behavior of the firmware. In some exemplary embodiments, the testing policy may include testing for abnormal behavior and functionality, on one hand, and testing for normal behavior of the firmware, on the other. In some exemplary embodiments, the one or more tests may be utilized to test the device's firmware, e.g., using black box testing, fuzz testing, or the like. In some exemplary embodiments, the testing agent may be configured to determine, implement, or the like, the testing policy. In some exemplary embodiments, the testing policy may be implemented by any other entity such as a user, a program, a device, a server, or the like.

In some exemplary embodiments, the testing agent may run the tests by itself. In such cases, the testing agent may prepare test files that define the tests to include a list of inputs, commands, outputs, or the like. The testing agent may execute the commands using a scripting language such as Bash™, Perl™, Python™, or the like. When the tests are completed, the testing agent may save the results of the tests in log files on a local storage or send the results to a server such as a remote server.

On step 320, during the testing phase, the testing agent may be configured to record in a log one or more events, states, activities, or parameters thereof (also referred to as “recorded events”), that are associated with the states and activities of the firmware. In some exemplary embodiments, the recorded events may be recorded periodically, continuously, or the like. In some exemplary embodiments, the testing agent may be configured to place in the log, in addition to the recorded events, a recorded timestamp of each recorded event which may enable swift and accurate correlation with testing results.

In some exemplary embodiments, the tests may be executed on the device while the testing agent is recording the internal events and states of the device. In some exemplary embodiments, the states or the activities of the device may comprise system call events, register contents, or the like. The testing agent may monitor the state of the device or firmware while responding to the inputs provided from the web server, and record at least some of the intended functionality, unintended functionality, or the like. In some cases, it may be possible to access the device by using remote commands, such as using Secure Shell (SSH) commands, telnet commands, via an Application Programming Interface (API), or the like. During the execution of the tests, the testing agent may periodically or continuously record the device's state and save it as a means to determine normal and abnormal behavior of the firmware.

In some exemplary embodiments, the testing results may be correlated with the recorded states of the firmware, e.g., based on timestamps, on contexts, on content, or the like. For example, timestamps of recorded states that occurred between a start time and an end time of a test may be merged with results of the test.

On step 330, constraints may be defined to differentiate between the normal and abnormal behavior, thereby allowing the normal behavior and preventing the abnormal behavior. In some exemplary embodiments, normal and legitimate behavior of the firmware or patterns thereof may be determined, detected, or the like, based on the association of the recorded states of the firmware with the testing results. In some exemplary embodiments, abnormal and illegitimate behavior of the firmware or patterns thereof may be determined, detected, or the like, based on the association of the recorded states of the firmware with the testing results.

On step 340, a runtime agent may be deployed at a kernel mode of an operating system over which the firmware is executed. In some exemplary embodiments, the runtime agent may comprise a software agent, a software program, or the like. In some exemplary embodiments, the runtime agent may be deployed after the testing phase is completed, during normal usage of the firmware outside of the testing environment. In some exemplary embodiments, the runtime agent may be employed instead of the testing agent after the testing agent completes the testing phase, or in addition to the testing agent. In some cases, a same agent may include both testing and runtime agents.

In some exemplary embodiments, the runtime agent may be configured to protect the firmware against exploitation of memory corruption attacks, e.g., during an execution of the firmware on the device. In some exemplary embodiments, the runtime agent may retain a list of constraints on an execution of system call events, e.g., determined based on the monitored events recorded by the general-purpose testing agent, based on static analysis, heuristics, or the like.

In some exemplary embodiments, detected real time system call events may be compared to the determined constraints, e.g., obtained from the testing agent, to classify the system call events as allowed or not allowed. In some cases, upon determining that a system call event is a normal event, the runtime agent may enable the system call event to proceed execution. In some cases, upon determining that the system call event is an abnormal event, the runtime agent may record states of the device, and perform remedial actions such as blocking the system call, terminating the system call event, blocking associated processes, reporting the system call event with the recorded states, providing an alert, or the like. In some exemplary embodiments, the report may be reported to a user, a producer of the runtime agent, or the like.

In some exemplary embodiments, the report may be submitted in real time upon identifying the event, at a predetermined offset from the identification of the event, at predetermined periods that do not depend on the identification of the system call event, or the like, e.g., by sending an e-mail, a notification, or the like. In some exemplary embodiments, sending information to the user, the producer of the runtime agent, or the like, may be performed in addition to or instead of performing a mitigation action such as blocking the abnormal system call, terminating the program, or the like.

In some exemplary embodiments, an unspecified system call event that is not specified as allowed or not allowed may be reported to a user, a producer of the runtime agent, or the like, to enable a discovery of a new required constraint on execution of the firmware.

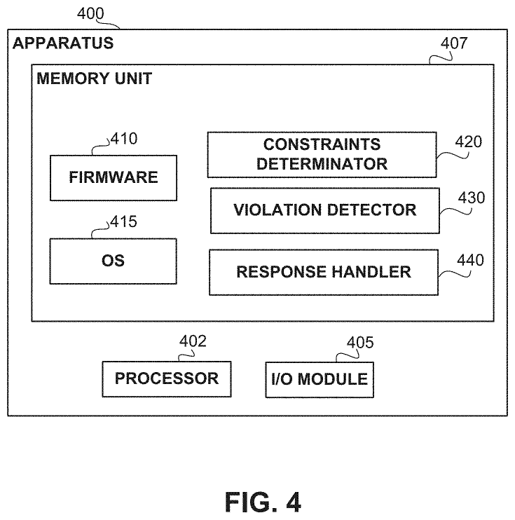

Referring now to FIG. 4 illustrating a block diagram of an apparatus, in accordance with some exemplary embodiments of the disclosed subject matter.

In some exemplary embodiments, an Apparatus 400 may comprise a Processor 402. Processor 402 may be a Central Processing Unit (CPU), a microprocessor, an electronic circuit, an Integrated Circuit (IC) or the like. Processor 402 may be utilized to perform computations required by Apparatus 400 or any of its subcomponents. Processor 402 may be configured to execute computer-programs useful in performing the methods of FIGS. 1-3, or the like.

In some exemplary embodiments of the disclosed subject matter, an Input/Output (I/O) Module 405 may be utilized to provide an output to and receive input from a user, another apparatus, or the like. I/O Module 405 may be operatively coupled to any peripheral device for receiving user input or providing user output. In some exemplary embodiments, I/O Module 405 may be used to transmit and receive information to and from the user or any other apparatus, e.g., a server, in communication therewith.

In some exemplary embodiments, Apparatus 400 may comprise a Memory Unit 407. Memory Unit 407 may be a short-term storage device or long-term storage device. Memory Unit 407 may be a persistent storage or volatile storage. Memory Unit 407 may be a disk drive, a Flash disk, a Random Access Memory (RAM), a memory chip, or the like. In some exemplary embodiments, Memory Unit 407 may retain program code operative to cause Processor 402 to perform acts associated with any of the subcomponents of Apparatus 400. In some exemplary embodiments, Memory Unit 407 may retain program code operative to cause Processor 402 to perform acts associated with any of the steps in FIGS. 1-3, or the like.

In some exemplary embodiments, Apparatus 400 may comprise or have access to a Firmware 410 which needs to be certified. I/O Module 405 may be operatively coupled to Firmware 410 which may be intended for inspection or verification. Firmware 410 may be a firmware product. In some exemplary embodiments, Firmware 410 may be a low-level software which can directly access hardware.

In some exemplary embodiments, Apparatus 400 may comprise or have access to an Operating System (OS) 415. In some exemplary embodiments, OS 415 may enable to execute Firmware 410 over OS 415.

In some cases, Apparatus 400 may be embedded within an IoT device, a computing device, or the like, that comprises Firmware 410. In some cases, Apparatus 400 may be in communication with an IoT device, a computing device, or the like, that comprises Firmware 410, such as via I/O Module 405. In some cases, a portion of Apparatus 400 may be embedded within the IoT device, and a portion of Apparatus 400 may be remote from the IoT device but in communication therewith. In some cases, Apparatus 400 may comprise Firmware 410, and may not be embedded or in communication with the IoT device.

The components detailed below may be implemented as one or more sets of interrelated computer instructions, executed for example by Processor 402 or by another processor. The components may be arranged as one or more executable files, dynamic libraries, static libraries, methods, functions, services, or the like, programmed in any programming language and under any computing environment.

In some exemplary embodiments, Constraints Determinator 420 may be configured to determine constraints on execution of system calls by Firmware 410. In some exemplary embodiments, Constraints Determinator 420 may be configured to determine constraints for system calls that are enabled, allowed, or the like, by the underlying OS 415 over which Firmware 410 is executed. For example, OS 415 may define that system calls may be enabled in case they comply with one or more OS constraints such as hardware constraints, timing constraints, delay constraints, or the like, while Constraints Determinator 420 may define that system calls that are enabled by OS 415, may be required to comply with one or more additional constraints determined by Constraints Determinator 420.

In some exemplary embodiments, Constraints Determinator 420 may determine the additional constraints by performing a dynamic analysis configured to differentiate between system call behavior during a normal operation of Firmware 410, and between system call behavior during an abnormal operation of Firmware 410 during such as attacks. In some exemplary embodiments, Constraints Determinator 420 may determine the constraints by performing a static analysis that is configured to analyze the binary of Firmware 410 and extract constraints therefrom. In some cases, Constraints Determinator 420 may obtain the constraints from a third party, e.g., a server.

In some exemplary embodiments, Violation Detector 430 may be configured to protect Firmware 410 against exploitation of memory corruption vulnerabilities, by determining whether constraints obtained from Constraints Determinator 420 are violated. In some exemplary embodiments, in case a system call event complies with OS constraints of OS 415, and violates the one or more constraints of Constraints Determinator 420, Violation Detector 430 may identify an exploitation. For example, after the OS constraints of OS 415 are complied with by a system call, Violation Detector 430 may evaluate the system call to determine whether it complies with the additional constraints of Constraints Determinator 420.

In some exemplary embodiments, Violation Detector 430 may deploy a runtime agent to detect, during execution of 410, every invocation of system call, and determine whether the system call complies with the constraints. In case Violation Detector 430 determines that a system call does not comply with the constraints, a violation may be determined. In some exemplary embodiments, the runtime agent may be executed on Firmware 410 without being part of an operating system such as OS 415 over which Firmware 410 is executed. In some exemplary embodiments, the runtime agent deployed by Violation Detector 430 may be stored in the memory of OS 415, in memory external to OS 415, and may or may not be dependent on OS 415. In some exemplary embodiments, Violation Detector 430 may deploy a single runtime agent per OS, multiple runtime agents per OS, or the like. For example, Violation Detector 430 may store multiple runtime agents within OS 415.

In some exemplary embodiments, Response Handler 440 may be configured to perform one or more responsive actions in response to obtaining a violation indication from Violation Detector 430, e.g., indicating that the constraints of Constraints Determinator 420 were violated. In some exemplary embodiments, a responsive action may include terminating the system call event, terminating the system call, terminating the system, reporting the system call event, generating a report of the system call event, or the like.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
obtaining metadata about a firmware, wherein the metadata comprises one or more constraints on execution of a system call by the firmware;
during execution of the firmware, identifying a system call event, wherein the system call event comprises an invocation of the system call;
determining that the system call event violates the one or more constraints on the execution of the system call; and
in response to said determining that the system call event violates the one or more constraints, performing a responsive action.

2. The method of claim 1, wherein the one or more constraints comprise a constraint over an argument value of an argument of the system call, wherein the constraint over the argument value excludes at least one legal value of the argument.

3. The method of claim 1, wherein the one or more constraints comprise a constraint on a call chain that invoked the system call, wherein the call chain comprises an ordered sequence of calling functions, wherein the method comprises:
analyzing a call stack to identify a current sequence of calling functions in the call stack; and
determining that the current sequence of calling functions violates the constraint on the call chain.

4. The method of claim 1, wherein the one or more constraints comprise a temporal constraint on arguments provided with the system call, wherein the temporal constraint is determined based on previous executions of the system call.

5. The method of claim 1, wherein the one or more constraints comprise a constraint on a calling function that invoked the system call.

6. The method of claim 5, wherein the constraint on the calling function that invoked the system call is a temporal constraint.

7. The method of claim 5, wherein the constraint comprises a constraint on a memory location of the calling function that invoked the system call, wherein one or more memory locations are authorized for the being calling functions of the system call, wherein the constraint defines that the memory location of the calling function must belong to the one or more memory locations.

8. The method of claim 1, wherein the one or more constraints comprise a constraint on a memory location from which the system call is invoked, wherein the constraint on the memory location is a constraint that the memory location is included in a collection of one or more authorized memory locations with respect to the system call.

9. The method of claim 1, wherein the metadata comprises a collection of one or more memory locations from which the system call can be invoked, wherein the one or more constraints on execution of the system call is based on the collection; wherein said determining that the system call event violates the one or more constraints on the execution of the system call comprises determining that the system call is invoked from a location that is not in the collection.

10. The method of claim 1, wherein the metadata is determined using at least one of:
static analysis performed without executing the firmware;
dynamic analysis performed by executing the firmware prior to the execution of the firmware, and prior to identifying the system call event;
symbolic execution performed while tracking symbolic values of the firmware; and
concolic execution performed while tracking both symbolic and concrete values of the firmware.

11. The method of claim 1, wherein the metadata is determined using dynamic analysis, wherein said dynamic analysis comprises:
obtaining a log generated during a training phase of the firmware, wherein during the training phase of the firmware, states and activities of the firmware are continuously polled and recorded in the log, wherein during the training phase the firmware is tested with a plurality of system call events;
correlating results of the training phase with states and activities recorded in the log to determine normal and abnormal behavior of the firmware during the plurality of system call events; and
based on said correlating, defining the one or more constraints on the execution of the system call.

12. The method of claim 11 comprising:
based on said correlating, mapping one or more abnormal behaviors of the firmware with one or more associated attack types utilized for testing the firmware during the training phase; and
based on said mapping the one or more abnormal behaviors, determining a risk score of the system call event.

13. The method of claim 1, wherein the metadata comprises a collection of one or more memory locations of one or more respective calling functions that are configured to call the system call, wherein the one or more constraints on execution of the system call is based on the collection; wherein said determining that the system call event violates the one or more constraints on the execution of the system call comprises determining that the system call is called by a function that is not listed in the collection.

14. The method of claim 1, wherein the responsive action comprises at least one of:
terminating the system call event;
terminating a process executing the system call; and
reporting the system call event,
wherein the method comprises determining a risk score of the system call event, wherein said performing the responsive action is performed based on the risk score of the system call event being above a threshold.

15. An apparatus comprising a processor and coupled memory, said processor being adapted to:
obtain metadata about a firmware, wherein the metadata comprises one or more constraints on execution of a system call by the firmware;
during execution of the firmware, identify a system call event, wherein the system call event comprises an invocation of the system call;
determine that the system call event violates the one or more constraints on the execution of the system call; and
in response to determining that the system call event violates the one or more constraints, perform a responsive action.

16. The apparatus of claim 15, wherein the processor is adapted to identify the system call event at a kernel mode of an operating system over which the firmware is executed.

17. The apparatus of claim 15, wherein said identifying the system call event, said determining that the system call event violates the one or more constraints on the execution of the system call, and said performing the responsive action are performed by a runtime agent that is executed on the firmware and which is not part of an operating system over which the firmware is executed.

18. The apparatus of claim 15, wherein the firmware is executed over an operating system, wherein the system call event complies with constraints of the operating system, and violates the one or more constraints.

19. The apparatus of claim 15, wherein the firmware is executed over an operating system, wherein the one or more constraints prevent a system call event that is allowed according to the operating system from being executed by the operating system.

20. A computer program product comprising a non-transitory computer readable storage medium retaining program instructions, which program instructions when read by a processor, cause the processor to:
obtain metadata about a firmware, wherein the metadata comprises one or more constraints on execution of a system call by the firmware;
during execution of the firmware, identify a system call event, wherein the system call event comprises an invocation of the system call;
determine that the system call event violates the one or more constraints on the execution of the system call; and
in response to determining that the system call event violates the one or more constraints, perform a responsive action.
